(19) United States
(12) Patent Application Publication
(10) Pub. No.: US 2014/0127556 A1
(43) Pub. Date: May 8, 2014

(54) LITHIUM SALT AND ELECTROLYTE SOLUTION AND LITHIUM BATTERY CONTAINING THE SAME

(71) Applicant: China Petrochemical Development Corporation, Taipei (Taiwan), Taipei City (TW)

(72) Inventor: Fu-Ming Wang, Taipei City (TW)

(73) Assignee: China Petrochemical Development Corporation, Taipei (Taiwan), Taipei City (TW)

(21) Appl. No.: 14/067,082

(22) Filed: Oct. 30, 2013

(30) Foreign Application Priority Data
Nov. 2, 2012 (TW) 101140673

(51) Int. Cl. H01M 10/0568; H01M 10/0525

(52) U.S. Cl. CPC H01M 10/0568; H01M 10/0525
USPC 429/163; 429/188; 429/199; 429/200; 429/337; 429/338; 429/342; 429/341; 548/310.4

(57) ABSTRACT

A lithium salt is disclosed. The lithium salt includes a lithium ion and an anion represented by formula (I),

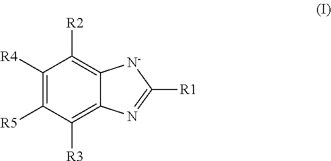

wherein R1 to R5 are independently selected from hydrogen atom, cyano group, fluorine atom, and C₁-C₅ alkyl group, in which the C₁-C₅ alkyl group is substituted with at least one fluorine atom. The present invention further provides an electrolyte solution and a lithium battery containing the lithium salt to enable a high conductivity of the battery at a high temperature.

### BACKGROUND OF THE INVENTION

1. Field of the Invention

This invention relates to a lithium salt, and more particularly, to a lithium salt used for a lithium battery, and an electrolyte solution and a lithium battery containing said lithium salt.

2. Description of Related Art

In recent years, due to the uses of lithium batteries in the new energy vehicles and energy storage systems, the market share of the lithium batteries increases from 2.5% to 20%. As forecasted by Zpryme Research & Consulting, LLC (US), the market size of the global intelligent network is projected to reach 171.4 billion US dollars by 2014. In the markets for terminal utilization, the latest Pike Research report also indicates that there will be 32,000 vehicles driven by alternative energy for the global bus markets in 2015. It will gradually drive the business expansion to increase the global demands of lithium batteries dramatically. This represents that the market for the electric drive vehicles and power batteries is approaching. Therefore, it is increasingly important to consider the design for the new thermostable lithium-ion batteries.

The so-called secondary lithium batteries are referred to the utilization of lithium ion in anode and cathode materials as circulated rechargeable and dischargeable batteries. Typically, graphite materials (such as maso carbon micro board, MCMB) are still employed as the anode materials in the commercially available secondary lithium batteries. In the initial charge-discharge cycle, the surface of graphite reacts with the electrolyte to form the passive protective layer (such as solid electrolyte interface, SEI) in the anode. Such passive protective layer is provided to prevent the collapse of the surface of the anode material and the degradation of the electrolyte, so as to stabilize the charge-discharge cycle of the batteries. This passive protective layer has a critical impact on the battery life. However, as for the batteries in high temperature environment for a long period of time, the lithium salt (typically lithium hexafluorophosphate, LiPF₆) of the electrolyte solution within the batteries can be easily degraded to strong Lewis acids, PF₅⁻ and HF, and they thereby destroy the structure of the electrode materials and the properties of the passive protective layer. Therefore, the battery's performance will be decayed along with the increasing temperature.

Typically, the commercially available electrolyte solution containing lithium hexafluorophosphate has high capacities and low costs, but its chemical structure is easily degradable at high temperature causing the battery expansion and performance deterioration, that affect the practical uses of the lithium batteries in electric drive vehicles. Most of the proposed solutions are as follows: using other electrode materials without the formation of the passive protective layer, adding different kinds of additives to the electrolyte solution to improve the properties of the passive protective layer, or modifying the surface of the particle prior to the preparation of the cathode/anode for preventing attacks. However, all these methods make the preparation steps of the battery more elaborate and complicated.

Accordingly, in order to overcome the above-mentioned problems of the lithium battery and the electrolyte solution, there are demands for the improvement in heat resistance and conductivity of the lithium salt.

### SUMMARY OF THE INVENTION

The present invention provides a lithium salt comprising a lithium ion and an anion represented by formula (I),

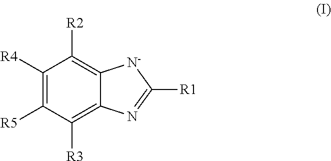

wherein R1 to R5 are independently selected from the group consisting of hydrogen atom, cyano group, fluorine atom, and C₁-C₅ alkyl group, in which the C₁-C₅ alkyl group is substituted with at least one fluorine atom.

In one embodiment, R2 to R5 of the lithium ion are cyano groups and R1 is —C₂H₄CF₃.

In another embodiment, R2 to R5 of the lithium ion are cyano groups and R1 is —CF₃.

The present invention further provides an electrolyte solution, which comprises an organic solvent and the lithium salt of the present invention.

The present invention also provides a lithium battery comprising the lithium salt of the present invention.

The electrolyte solution comprising the thermostable lithium salt of the present invention can provide good ionic conductivities and very positive results for the cycle life of the batteries at high temperatures. Thus, it can be effectively applied in the operation environment of the engines for electric drive vehicles.

### BRIEF DESCRIPTION OF THE DRAWINGS

FIG. 1 is a diagram showing the cross section of the lithium battery of the present invention;

FIG. 2 is the infrared spectrum of the product (4-cyano-2-trifluorobutyl benzimidazole) at stage 2 of Example 1;

FIG. 3 is the infrared spectrum of the lithium salts synthesized at any stage of Example 1;

FIG. 4 is the 1H-NMR spectrum of the lithium salt synthesized in Example 2;

FIG. 5 is the test chart of the conductivity of the electrolyte solutions of Example 1 and Comparative Example 1; and FIG. 6 is the test result of the ion conductivity of the electrolyte solution C in the temperature variation experiment.

### DETAILED DESCRIPTION OF THE PREFERRED EMBODIMENTS

The following specific examples are used for illustrating the technical content and embodiments of the present invention in details. A person skilled in the art can easily conceive the advantages and effects of the present invention based on the disclosure. This invention can also be implemented or applied through other different embodiments. While some of the embodiments of the present invention have been described in detail, it is, however, possible for those of ordinary skilled in the art to make various modifications and changes to the particular embodiments shown without substantially departing from the teaching and advantages of the present invention.

It should be understood that all structures, ratios, sizes and the like included in the drawings are merely illustrative to demonstrate the disclosure of the specification to aid the understanding and reading for those of ordinary skilled in the art without providing substantial technical meanings, and not intended to limit the scope of the present invention. Any modifications of the structures, such as the changes of ratio relationships and size adjustments, should be covered under the scopes of the technical content of the present invention, as long as they do not affect the produced effects and achievable goals of the present invention. Further, the terms of “upper”, “lower”, “top”, “bottom”, “one” and more are merely for illustrative purpose and should not be construed to limit the scope of the present invention. The changes and adjustments of the relative relationships should be covered under the implementation scope of the present invention without changing technical content substantially.

The present invention provides a lithium salt comprising a lithium ion and an anion represented by formula (I),

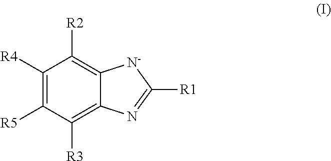

wherein R1 to R5 are independently selected from the group consisting of hydrogen atom, cyano group, fluorine atom and C₁-C₅ alkyl group, in which the C₁-C₅ alkyl group is substituted with at least one fluorine atom. In one embodiment, R1 is fluoro or C₁-C₃ perfluoroalkyl group; R2 and R3 are independently selected from fluorine atom and cyano group. The C₁-C₅ alkyl group substituted with at least one fluorine atom can be partially substituted as —CH₂F, —C₂H₄CF₃, —C₃H₆C₂F₅, —C₁H₂C₂F₅, —C₂F₄CH₃, or the like, or also can be C₁-C₅ perfluoroalkyl group.

The term “perfluoroalkyl group” used herein refers to the alkyl group, in which all hydrogen atoms in the carbon chains are substituted with fluorine atoms, such as —CF₃, —C₂F₅, —C₃F₇ or C₅F₁₁ and the like.

In one embodiment, each of R2 to R5 of the lithium salt is cyano group and R1 is —C₂H₄CF₃.

In another embodiment, each of R2 to R5 of the lithium salt is cyano group and R1 is —CF₃.

In one embodiment, an electrolyte solution comprising organic solvents and the lithium salt of the present invention is provided.

The electrolyte solutions may be, but not limited to, γ-butyrolactone (GBL), ethylene carbonate (EC), propylene carbonate (PC), diethyl carbonate (DEC), propyl acetate (PA), dimethyl carbonate (DMC) or ethylmethyl carbonate (EMC).

In addition, besides using the lithium salt of the present invention, the electrolyte solution of the present invention can also be mixed with other lithium salts, for example, LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, or LiCF₃SO₃.

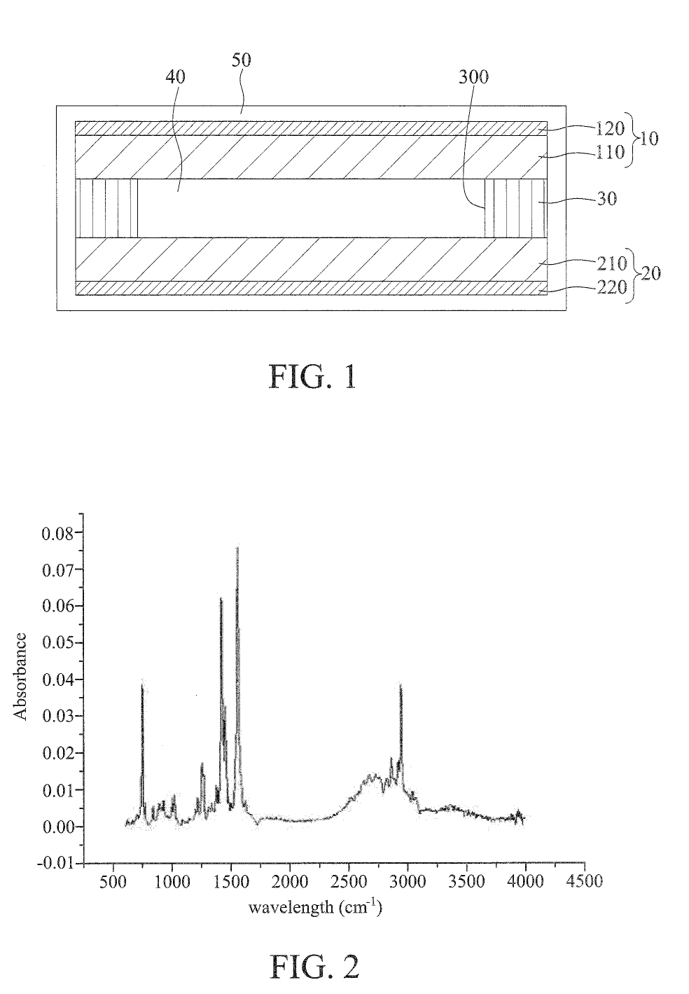

The electrolyte solution of the present invention can be used in a lithium battery and the structure of the lithium battery is illustrated in FIG. 1. The lithium battery includes an anode 10; a cathode 20 and a separation membrane 30 interposed between the anode 10 and the cathode 20, wherein the separation membrane 30 has a through opening 300 so as to form an accommodating space 40 with the anode 10 and the cathode 20 for accommodating the electrolyte solution of the present invention.

In a preferred embodiment, the anode 10 comprises a first conductive element 110 and an anode metal foil 120 which is formed on the first conductive element 110, so that the first conductive element 110 is interposed between the separation membrane 30 and the anode metal foil 120. The separation membrane 30 is disposed on the first conductive element 110 and has a through opening 300 for partially exposing the first conductive element 110.

The cathode 20 comprises a second conductive element 210 and a cathode metal foil 220 formed on the second conductive element 210, so that the second conductive element 210 is interposed between the separation membrane 30 and the cathode metal foil 220, and an accommodating space 40 is formed by the separation membrane 30, the first conductive element 110 and the second conductive element 210 for accommodating the electrolyte solution.

In one example, the lithium battery further comprises an encapsulating structure 50 (like encapsulated plastic) for encapsulating the anode 10, the cathode 20 and the separation membrane 30.

In the lithium battery of the present invention, the material of the first conductive element 110 may be lithium or carbide, wherein the carbide is at least one selected from the group consisting of carbon powder, graphite, carbon fiber, carbon nanotube and graphene. In an embodiment, the carbide is carbon powder having the average particle diameter of 100 nm to 30 μm.

In the lithium battery of the present invention, the second conductive element can be a transition metal oxide mixed with lithium, wherein the transition metal oxide mixed with lithium can be at least one selected from the group consisting of LiMnO₂, LiMn₂O₄, LiCoO₂, Li₂Cr₂O₇, Li₂CrO₄, LiNiO₂, LiFeO₂, LiNiₓCo₁₋ₓO₂, LiFePO₄, LiMn_{0.5}Ni_{0.5}O₂, LiMn_{1/3}Co_{1/3}Ni_{1/3}O₂ and LiMc_{0.5}Mn_{1.5}O₄, wherein 0<x<1 and Mc is the divalent 3d transition metal.

The anode metal foil 120 and the cathode metal foil 220 can be common metal foils, such as copper foil, aluminum foil, nickel foil, silver foil, gold foil, platinum foil and stainless steel sheet.

The lithium battery of the present invention can further comprise a binder (not shown in the drawings) for adhering the anode metal foil and the first conductive element and for adhering the cathode metal foil and the second conductive element, wherein the binder may be polyvinylidene fluoride (PVDF), styrene-butadiene rubber (SBR), polyamide or melamine resin.

The separation membrane 30 can be the insulating material which is selected from polyethylene (PE), polypropylene (PP) and a combination thereof. The insulating material can be a multilayer structure, such as composite multilayer structure of PE-PP-PE.

In order to improve the cycle life of the lithium battery at high temperature, the present invention utilizes the chemical synthesis method to synthesize the specific functional groups (such as —CH₃, —F, —CN, —CF₃ and the like) in the main structure of the benzimidazole molecules. The lithium salt which is formed by this anion group is used in the electrolyte solution of the commercial lithium battery. The ionic conductivities of the electrolyte mixture are determined at different temperatures.

The following examples are described in details to illustrate the above and other goals, features and advantages of the present invention.

### Example 1

1 mole of 3,4,5,6-4-cyano-nitroaniline as the precursor was dissolved in 50 g of ethanol and added with an excess (approximately 1.1 mole) of hydrazine (N₂H₄). The reaction of the mixture was performed at 80° C. for 3 to 4 hours. After completing the reaction, the residual and unreacted solid impurities in the solution were filtered and removed, and then the solvent was partially (about 90% of the quantity) removed by using a rotating evaporator. The remaining 10% of solution was recrystallized at 4 to 5° C.

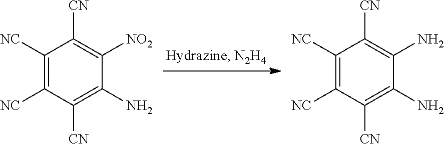 [SMILES: N#Cc1c(N)c([N+](=O)[O-])c(C#N)c(C#N)c1C#N ; N#Cc1c(N)c(N)c(C#N)c(C#N)c1C#N]

Light brown crystals appeared in the glass vial after overnight incubation. The crystals were taken out and determined the melting point as 104 to 106° C. using a differential scanning calorimeter (DSC). The compound structures of the crystals were also determined as 3,4,5,6-4-cyano-diamine benzene by Fourier transform infrared spectroscopy (FTIR) and nuclear magnetic resonance (NMR).

0.05 mole of the above 3,4,5,6-4-cyano-diamine benzene and 0.01 mole of 4,4,4-trifluorobutyric acid were dissolved in 50 g of ethanol to form a mixture, and the mixture was proceeded to the azeotropic reaction for 3 hours (100° C.). After completion of the reaction, the mixed solution was cooled to room temperature. The reaction scheme is shown as follows.

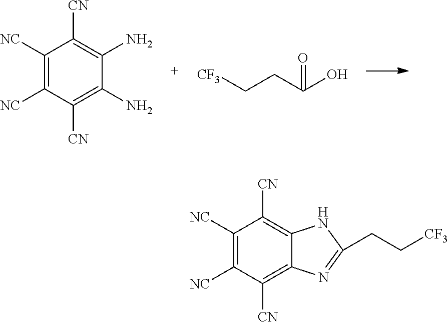 [SMILES: N#Cc1c(N)c(N)c(C#N)c(C#N)c1C#N ; O=C(O)CCC(F)(F)F ; N#Cc1c(C#N)c(C#N)c2[nH]c(CCC(F)(F)F)nc2c1C#N]

Subsequently, the pH of the mixed solution was adjusted to the range of 7 to 8 by sodium hydroxide solution (20% wt). Activated carbon was added to the pH-adjusted solution, and then the solution was heated to 100° C. to react for 45 minutes. The solution was filtered and cooled to room temperature, and then left overnight at 4 to 5° C. Yellow crystals were formed on the wall of the vial. The structures of the crystals at the second stage were determined and confirmed as 4-cyano-2-trifluorobutyl benzimidazole using FTIR and NMR, while the melting point test showed the interval of 150 to 152° C. According to the infrared spectrum shown in FIG. 2, it can be found that the specific functional group, CF₃, is shown in 1100 to 1300 nm⁻¹, the alkyl chain is present in 2800 to 3000 nm⁻¹ and the C═C and C—N on the benzene ring of the original structure are still present in 1600 nm⁻¹ and 1100 nm⁻¹. This shows that the 4-cyano-2-trifluorobutyl benzimidazole had been correctly synthesized at the second stage while the melting test shows the interval of 150 to 152° C.

Subsequently, the reaction shown in the following reaction scheme was carried out using Li₂CO₃.

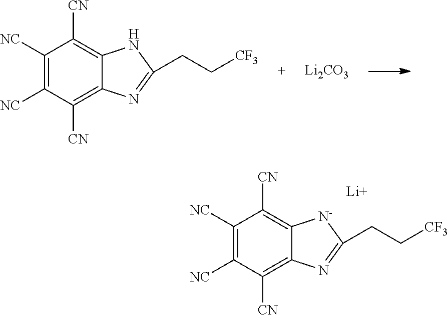

1 mole of 4-cyano-2-trifluorobutyl benzimidazole and 0.5 mole of Li₂CO₃ were dissolved in 100 g of ethanol to form a mixed solution and stirred evenly at room temperature for 4 hours. After filtering the solid impurities and concentrating, light yellow lithium crystals were obtained.

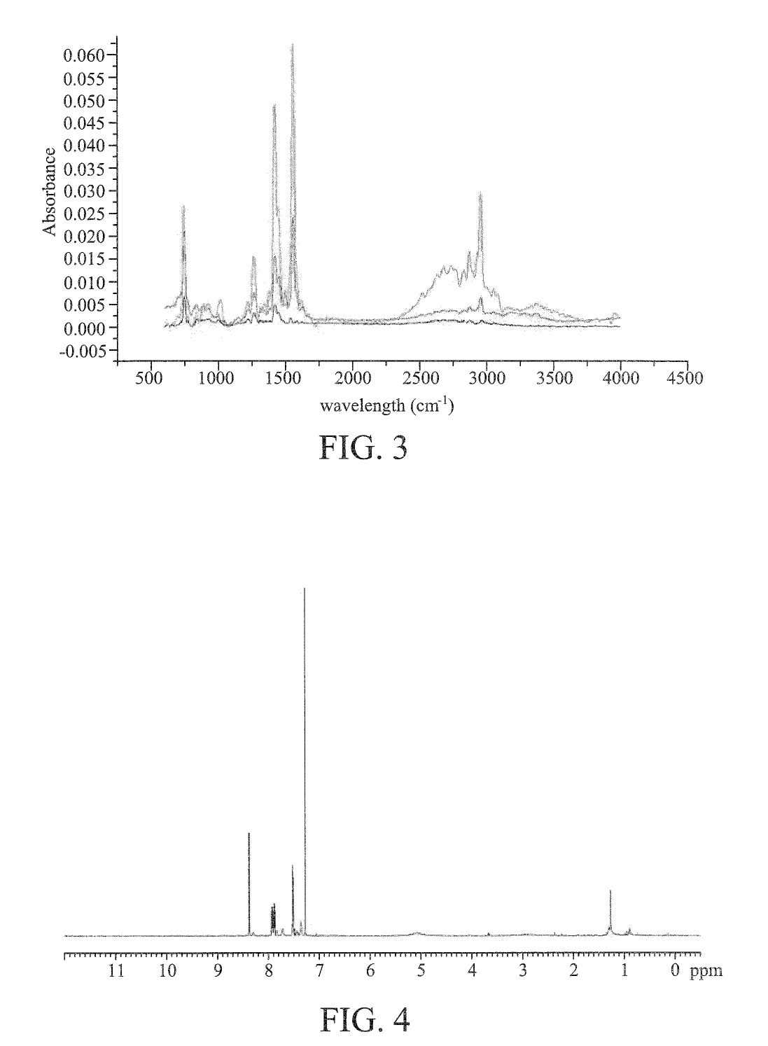

According to the infrared spectrum shown in FIG. 3, the highest point in the 3400 cm⁻¹ interval is the spectrum of 4-cyano-2-trifluorobutyl benzimidazole shown in FIG. 2. The characteristic peak of the —NH— functional group is decreased with the increased amount of Li₂CO₃. This shows that the original 4-cyano-2-trifluorobutyl benzimidazole was gradually transformed to lithium 4-cyano-2-trifluorobutyl benzimidazolide by lithium carbonate.

2 parts by volume of EC, 3 parts by volume of PC and 5 parts by volume of DEC were mixed as the organic solvents of the electrolyte solution. 1M of electrolyte solution B was prepared by using the lithium salt of this example.

### Example 2

75.3 mmol of benzimidazole and 50 mL of toluene were added to a reactor, mixed and stirred at circulation of high purity nitrogen and ice bath for about 1 hour, and then 74.2 mmol of n-butyl lithium were added dropwise to the reactor using quantitative buret. The mixture was stirred at ice bath for 3 to 4 hours until white smoke and exothermic phenomenon disappeared completely, rinsed three times with toluene, filtered and dried, and a light yellow lithium salt having the following formula (II) was obtained. The completion of the replacement of lithium ions was confirmed by NMR spectrum. As shown in FIG. 4, the spectrum of —NH— functional group disappeared completely at 8.5 to 8.7 ppm and it was confined that benzimidazole had been replaced with lithium benzimidazolide completely and correctly.

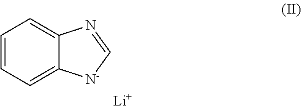

The above synthesized lithium salt was dissolved in the electrolyte solution which was prepared by 10 parts by weight of BF₃((C₂H₅)₂O) and 90 parts by weight of mixed solvent (the solvent contained 2 parts by volume of EC, 3 parts by volume of PC and 5 parts by volume of DEC) to form 1M of electrolyte solution C.

### Comparative Example 1

The commercially available lithium hexafluorophosphate (UNION CHEMICAL IND. CO., LTD.) was purchased as a lithium salt and used to prepare the electrolyte solution A in the same manner as the preparation of solvent in Example 1 with same composition and ratio.

### Test Example—Measurement of Conductivity of Lithium Ion

At room temperature, 50° C., 70° C. and 90° C., the impedance variations of the electrolyte solutions in Example 1 and Comparative Example 1 were determined at a constant voltage (5 mV) by an AC impedance spectroscopy (Biologic), and the conductivity (σ) value and the activation energy (Ea) were also calculated.

The conductivity (σ) is calculated by the following equation:

$$σ = \frac{L}{RA}$$

wherein L is the distance between two electrodes, A is the area of the electrodes and R is the impedance value obtained by the AC impedance spectroscopy.

The prepared electrolyte solution of Example 1 changed from transparent to transparent light yellow, and this represented that the lithium salt was completely dissolved in the electrolyte solution without precipitation. Similarly, the lithium salt was completely dissolved in the electrolyte solution of Example 2.

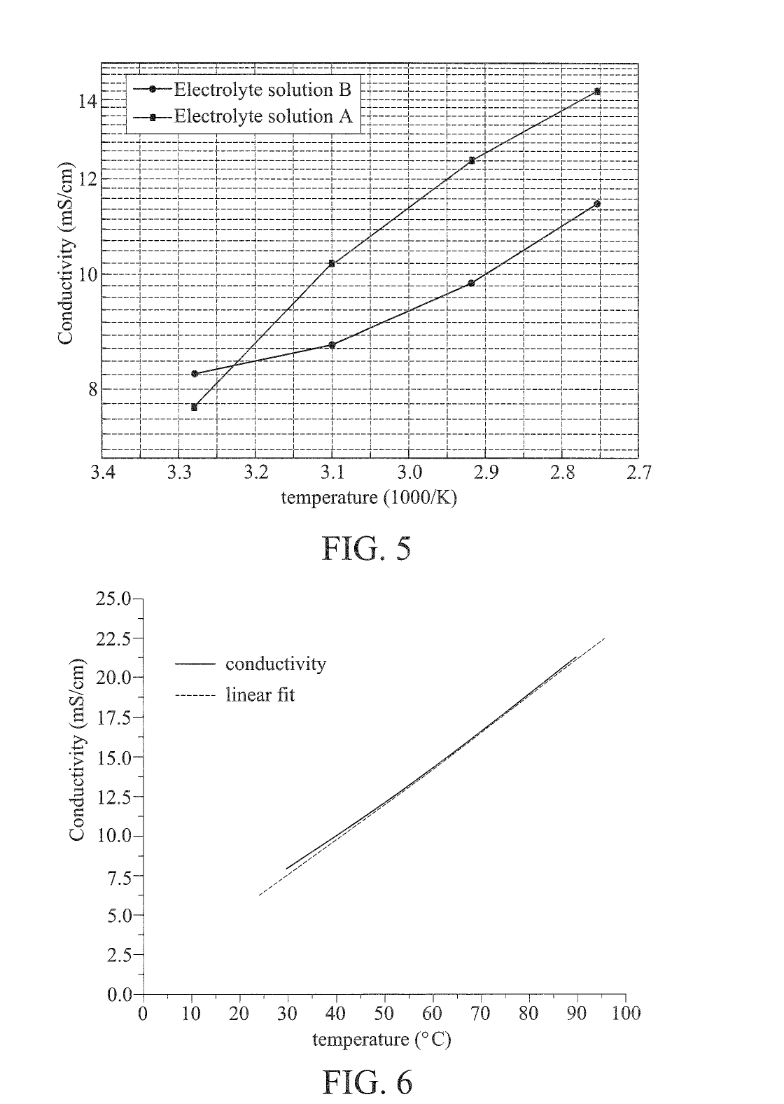

In the conductivity test, FIG. 5 shows that the electrolyte solution B having the lithium salt of Example 1 has the conductivity of 7.7 mS/cm at room temperature and the electrolyte solution A of Comparative Example 1 has 8.4 mS/cm. However, as indicated in the temperature variation experiments with increased temperatures, the electrolyte solution B of Example 1 has good dissociation ability, and ion transfer process can occur more easily at higher temperature environment. The electrolyte solution B provides conductivities of 10.2 mS/cm, 12.4 mS/cm, 14.2 mS/cm at 40° C., 60° C. and 90° C. respectively, which are greater than that of Comparative Example 1.

FIG. 6 is the test results of the ion conductivity of the electrolyte solution C in Example 2 by the temperature variation experiment. According to FIG. 6, the electrolyte solution C developed in Example 2 provides the conductivities of 8.9 mS/cm, 10.2 mS/cm and 11.6 mS/cm respectively at 40° C., 60° C. and 90° C. As shown in FIG. 6, the conductivity of the electrolyte solution C is increased with the increased temperature and it can be found that the conductivity of the electrolyte solution is about 7.5 mS/cm at room temperature. This represents that the mixed electrolyte solution C has a good ion transfer property.

The above-mentioned embodiments are described to illustrate the principles and effects of the present invention, and they do not impose any limitations to the present invention. It is, however, possible for those of ordinary skills in the art to make modifications to the above-mentioned embodiments without substantially departing from the teaching and advantages of the present invention. Such modifications and changes are encompassed in the spirit and scope of the present invention as set forth in the appended claim.

What is claimed is:

1. A lithium salt, comprising:
a lithium ion; and
an anion of formula (I) 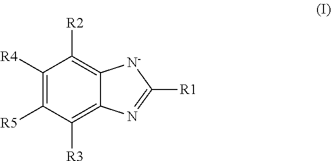
wherein R1 to R5 are independently selected from the group consisting of hydrogen atom, cyano, fluorine atom and C₁-C₅ alkyl group, in which the C₁-C₅ alkyl group is substituted with at least one fluorine atom.

2. The lithium salt of claim 1, wherein each of R2 to R5 is cyano and R1 is —C₂H₄CF₃.

3. The lithium salt of claim 1, wherein each of R2 to R5 is cyano and R1 is —CF₃.

4. An electrolyte solution, comprising an organic solvent and the lithium salt of claim 1.

5. The electrolyte solution of claim 4, wherein the organic solvent is selected from the group consisting of γ-butyrolactone, ethylene carbonate, propylene carbonate, diethyl carbonate, propyl acetate, dimethyl carbonate and ethylmethyl carbonate.

6. A lithium battery, comprising the electrolyte solution of claim 4.

7. The lithium battery of claim 6, further comprising:
an anode;
a cathode;
a separation film interposed between the anode and the cathode and having a through opening so as to form an accommodating space with the anode and the cathode for accommodating the electrolyte solution of claim 4.

8. The lithium battery of claim 7, wherein the anode comprises a first conductive element and an anode metal foil formed on the first conductive element, so that the first conductive element is interposed between the separation membrane and the anode metal foil; and the cathode comprises a second conductive element and a cathode metal foil formed on the second conductive element, so that the second conductive element is interposed between the separation film and the cathode metal foil and an accommodating space is formed by the separation membrane, the first conductive element and the second conductive element for accommodating the electrolyte solution of claim 4.

9. The lithium battery of claim 7, further comprising an encapsulating structure for encapsulating the anode, the cathode and the separation film.

10. The lithium battery of claim 8, wherein the first conductive element is lithium or carbide.

11. The lithium battery of claim 10, wherein the carbide is at least one selected from the group consisting of carbon powder, graphite, carbon fiber, carbon nanotube and graphene.

12. The lithium battery of claim 11, wherein the average particle diameter of the carbon powder is in a range from 100 nm to 30 μm.

13. The lithium battery of claim 8, wherein the second conductive element is a transition metal oxide mixed with lithium.

14. The lithium battery of claim 13, wherein the transition metal oxide mixed with lithium is at least one selected from the group consisting of LiMnO₂, LiMn₂O₄, LiCoO₂, Li₂Cr₂O₇, Li₂CrO₄, LiNiO₂, LiFeO₂, LiNiₓCo₁₋ₓO₂, LiFePO₄, LiMn_{0.5}Ni_{0.5}O₂, LiMn_{1/3}Co_{1/3}Ni_{1/3}O₂ and LiMc_{0.5}Mn₁₅O₄, wherein 0<x<1 and Mc is a divalent 3d transition metal.

15. The lithium battery of claim 8, further comprising a binder for adhering the anode metal foil to the first conductive element and for adhering the cathode metal foil to the second conductive element.

16. The lithium battery of claim 15, wherein the binder is selected from the group consisting of polyvinylidene fluoride, styrene-butadiene rubber, polyamide and melamine resin.

17. The lithium battery of claim 7, wherein the separation film is selected from the group consisting of polyethylene, polypropylene and a combination thereof.
